(19) United States
(12) Patent Application Publication
(10) Pub. No.: US 2015/0017482 A1
(43) Pub. Date: Jan. 15, 2015

(54) METHOD FOR FABRICATING PLASMONIC CLADDING

(71) Applicant: Seagate Technology LLC, Cupertino, CA (US)

(72) Inventors: Kim Y. Lee, Fremont, CA (US); Ganping Ju, Pleasanton, CA (US); Chubing Peng, Eden Prairie, MN (US); Xiaobin Zhu, San Ramon, CA (US); Yingguo Peng, San Ramon, CA (US); Yukiko A. Kubota, Campbell, CA (US); Timothy J. Klemmer, Fremont, CA (US); Jan-Ulrich Thiele, Sunnyvale, CA (US); Michael A. Seigler, Eden Prairie, MN (US); Werner Scholz, Edina, MN (US); David S. Kuo, Palo Alto, CA (US); Koichi Wago, Sunnyvale, CA (US); Thomas P. Nolan, Fremont, CA (US)

(73) Assignee: Seagate Technology LLC, Cupertino, CA (US)

(21) Appl. No.: 14/055,799

(22) Filed: Oct. 16, 2013

Related U.S. Application Data
(60) Provisional application No. 61/844,420, filed on Jul. 9, 2013.

(51) Int. Cl. G11B 5/72; G11B 5/74; G11B 5/84

(52) U.S. Cl. CPC G11B 5/72; G11B 5/8408; G11B 5/746
USPC 428/833.1; 427/127; 427/131; 216/22; 427/554; 428/834

(57) ABSTRACT

The embodiments disclose a plasmonic cladding structure including at least one conformal plasmonic cladding structure wrapped around plural stack features of a recording device, wherein the conformal plasmonic cladding structure is configured to create a near-field transducer in close proximity to a recording head of the recording device, at least one conformal plasmonic cladding structure with substantially removed top surfaces of the stack features with exposed magnetic layer materials and a thermally insulating filler configured to be located between the stack features.

### CROSS-REFERENCE TO RELATED APPLICATIONS

This application claims the benefit of U.S. Provisional Patent Application Ser. No. 61/844,420 filed Jul. 9, 2013, entitled “A METHOD OF FABRICATING BPM PATTERNED HAMR MEDIA WITH PLASMONIC CLADDING”, by Ju, et al.

### BRIEF DESCRIPTION OF THE DRAWINGS

FIG. 1 shows a block diagram of an overview of a method for fabricating plasmonic cladding of one embodiment.

FIG. 2 shows a block diagram of an overview flow chart of a method for fabricating plasmonic cladding of one embodiment.

FIG. 3 shows a block diagram of an overview flow chart of a conformal plasmonic cladding layer deposition of one embodiment.

FIG. 4 shows a block diagram of an overview flow chart of partially etching the conformal plasmonic cladding layer of one embodiment.

FIG. 5 shows a block diagram of an overview flow chart of improving NFT-media coupling efficiency of one embodiment.

FIG. 6A shows for illustrative purposes only an example of a HAMR stack of one embodiment.

FIG. 6B shows for illustrative purposes only an example of etching a BPM first magnetic recording pattern of one embodiment.

FIG. 6C shows for illustrative purposes only an example of etching a BPM second magnetic recording pattern of one embodiment.

FIG. 7A shows for illustrative purposes only an example of a first BPM patterned feature of one embodiment.

FIG. 7B shows for illustrative purposes only an example of a second BPM patterned feature of one embodiment.

FIG. 8A shows for illustrative purposes only an example of first conformal plasmonic cladding of one embodiment.

FIG. 8B shows for illustrative purposes only an example of second conformal plasmonic cladding of one embodiment.

FIG. 9A shows for illustrative purposes only an example of etching first conformal plasmonic cladding layer in the BPM feature trenches of one embodiment.

FIG. 9B shows for illustrative purposes only an example of etching second conformal plasmonic cladding layer in the BPM feature trenches of one embodiment.

FIG. 10A shows for illustrative purposes only an example of partially etched first conformal plasmonic cladding down to the IL & TR layer of one embodiment.

FIG. 10B shows for illustrative purposes only an example of partially etched second conformal plasmonic cladding down to HS2 of one embodiment.

FIG. 11A shows for illustrative purposes only an example of a first thermally insulating filler deposition of one embodiment.

FIG. 11B shows for illustrative purposes only an example of a second thermally insulating filler deposition of one embodiment.

FIG. 12A shows for illustrative purposes only an example of first BPM patterned dot patterned plasmonic cladding of one embodiment.

FIG. 12B shows for illustrative purposes only an example of second BPM patterned dot patterned plasmonic cladding of one embodiment.

FIG. 13 shows for illustrative purposes only an example of avoiding lateral thermal bloom of one embodiment.

FIG. 14 shows for illustrative purposes only an example of a second BPM patterned feature with wrap around plasmonic cladding of one embodiment.

FIG. 15 shows for illustrative purposes only an example of a first multi-layer conformal plasmonic cladding layer of one embodiment.

FIG. 16 shows for illustrative purposes only an example of a second multi-layer conformal plasmonic cladding layer of one embodiment.

FIG. 17 shows for illustrative purposes only an example of directional vertical etching of one embodiment.

FIG. 18 shows for illustrative purposes only an example of patterned BPM feature multi-layer plasmonic cladding wrap of one embodiment.

### DETAILED DESCRIPTION

In a following description, reference is made to the accompanying drawings, which form a part hereof, and in which is shown by way of illustration a specific example in which the embodiments may be practiced. It is to be understood that other embodiments may be utilized and structural changes may be made without departing from the scope.

### General Overview:

It should be noted that the descriptions that follow, for example, in terms of a method for fabricating plasmonic cladding is described for illustrative purposes and the underlying system can apply to any number and multiple types of magnetic recording patterns. In one embodiment, the method for fabricating plasmonic cladding can be configured using one or more layers of plasmonic cladding materials. The method for fabricating plasmonic cladding can be configured to include two or more thermally gradient heat sink layers and can be configured to include two or more anisotropic gradient magnetic layers.

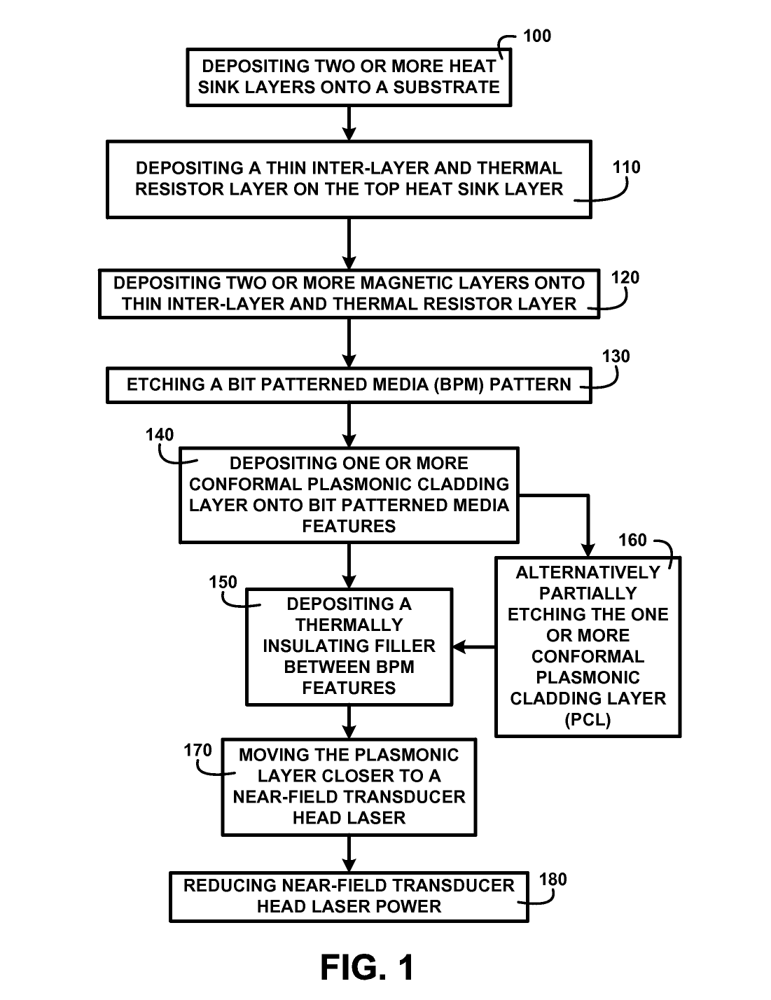

FIG. 1 shows a block diagram of an overview of a method for fabricating plasmonic cladding of one embodiment. FIG. 1 shows a fabrication process including depositing two or more heat sink layers onto a substrate 100. The processing includes depositing a thin inter-layer and thermal resistor layer on the top heat sink layer 110. The fabrication continues by depositing two or more magnetic layers onto thin inter-layer and thermal resistor layer 120. Partially etching a bit patterned media (BPM) pattern 130 into the stacked layers creates bit patterned media features. The process continues with depositing one or more conformal plasmonic cladding layer onto bit patterned media features 140. A patterning process includes partially etching the one or more conformal plasmonic cladding layer (PCL) 160 to pattern the PCL. The patterned PCL is insulated by depositing a thermally insulating filler between BPM features 150 of one embodiment.

A method for fabricating plasmonic cladding is configured to wrap the plasmonic cladding around the patterned bit patterned media features to amplify optical coupling and NFT-media coupling. Typically in a HAMR stack a plasmonic underlayer is positioned between the substrate and a continuous heat sink layer. Moving the plasmonic layer closer to a near field transducer head laser 170 increases efficiency in optical coupling efficiency and reducing near field transducer head laser power 180, for example to a power level <50 nW at the top surface of a stack feature including a bit patterned media feature, thereby extending the useful life of the NFT of one embodiment.

### DETAILED DESCRIPTION

Plasmonic devices use plasmonic materials to efficiently confine optical fields at a nanoscale to locally heat a recording medium for data storage in a heat assisted magnetic recording (HAMR) stack including bit patterned media (BPM). The confining of near field optical effects transmitted from a near field transducer (NFT) including a laser to temporarily heat the magnetic medium to lower the switching field of high-anisotropy, small grain media of one embodiment.

After the media is written, it cools rapidly (<1 ns) for long-term storage. Because the size, for example the nanoscaled grains of a patterned magnetic layers in a bit patterned media stack, of the region to be heated in the media is well below the optical diffraction limit, a writer must use a near field device such as a plasmonic device made of a low loss metal (gold, silver, copper) for the creation of resonant charge motion at the metal surface of one embodiment.

Thermal conductivity is the measure of the speed of heat flow passed from particle to particle. The rate of heat flow through a specific material will be influenced by the difference of temperature and by its thermal conductivity. Thermal conductivity is a measure of the capacity of a material to conduct heat through its mass. It can be defined as the amount of heat/energy (expressed in kcal, Btu or J) that can be conducted in unit time through unit area of unit thickness of material, when there is a unit temperature difference. Thermal conductivity is also known as the k-value and can be expressed in the SI system in watt (W) m−1° C-1 of one embodiment.

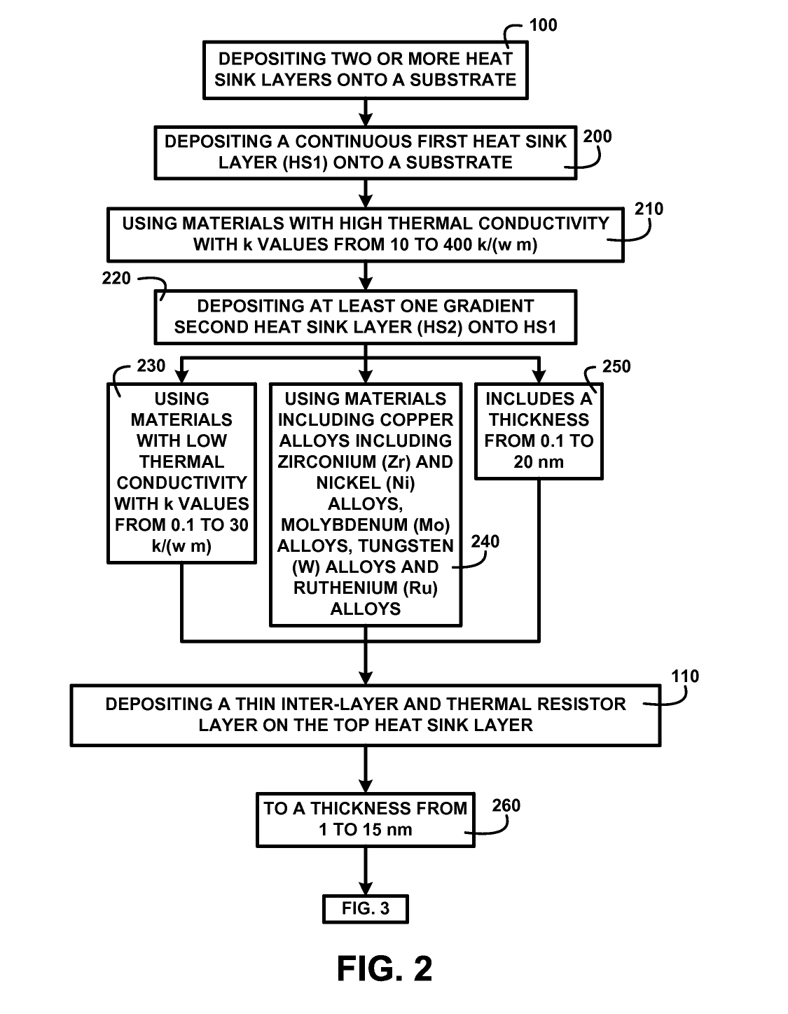

FIG. 2 shows a block diagram of an overview flow chart of a method for fabricating plasmonic cladding of one embodiment. FIG. 2 shows depositing two or more heat sink layers onto a substrate 100 including depositing a continuous first heat sink layer (HS1) onto a substrate 200. The deposition of HS1 includes using materials with high thermal conductivity with k values from 10 to 400 k/(w m) 210. Depositing two or more heat sink layers onto a substrate 100 includes depositing at least one gradient second heat sink layer (HS2) onto HS1 220 of one embodiment.

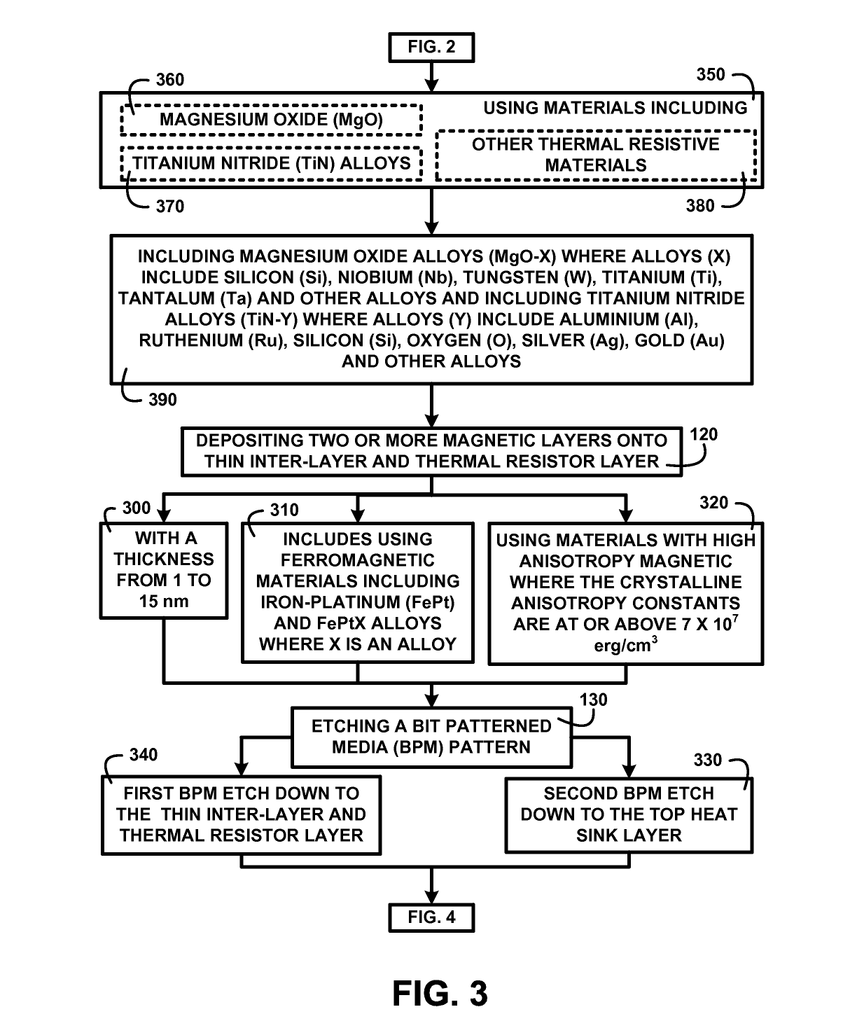

The deposition of at least one gradient second heat sink layer includes using materials with low thermal conductivity with k values from 0.1 to 30 k/(w m) 230. Depositing at least one gradient second heat sink layer includes using materials including copper alloys including Zirconium (Zr) and nickel (Ni) alloys, molybdenum (Mo) alloys, tungsten (W) alloys and Ruthenium (Ru) alloys 240 and includes a thickness from 0.1 to 20 nm 250. The fabrication process includes depositing a thin inter-layer and thermal resistor layer on the top heat sink layer 110 to a thickness from 1 to 15 nm 260. Description of the fabrication process continues on FIG. 3 of one embodiment.

FIG. 3 shows a block diagram of an overview flow chart of a conformal plasmonic cladding layer deposition of one embodiment. FIG. 3 shows a continuation from FIG. 2 including the deposition of the thin inter-layer and thermal resistor layer including using materials including 350 magnesium oxide (MgO) 360, titanium nitride (TiN) alloys 370 and other thermal resistive materials 380 including magnesium oxide alloys (MgO—X) where alloys (X) include silicon (Si), niobium (Nb), tungsten (W), titanium (Ti), tantalum (Ta) and other alloys and including Titanium nitride alloys (TiN—Y) where alloys (Y) include aluminum (Al), ruthenium (Ru), silicon (Si), oxygen (O), silver (Ag), gold (Au) and other alloys 390.

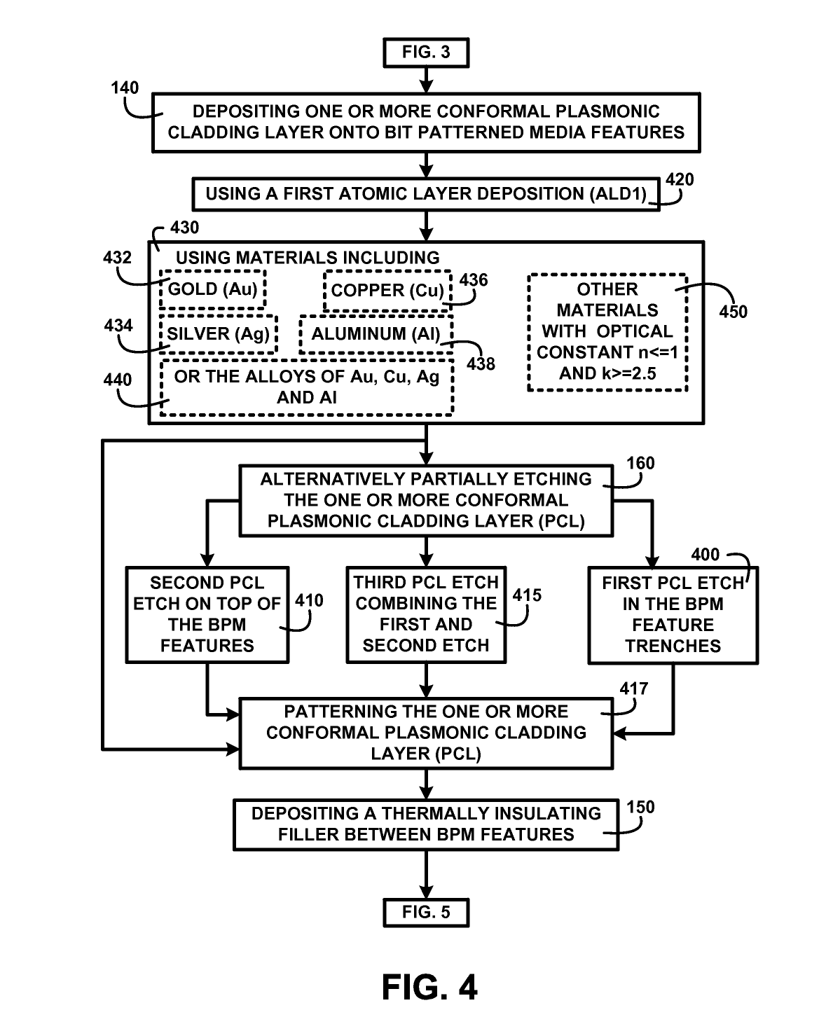

The fabrication continues with a deposition process including depositing two or more magnetic layers onto thin inter-layer and thermal resistor layer 120 with a thickness from 1 to 15 nm 300. The deposition of the magnetic layers includes using ferromagnetic materials including iron-platinum (FePt) and FePtX alloys where X is an alloy 310. The deposition of the magnetic layers includes using materials with high anisotropy magnetic where the crystalline anisotropy constants are at or above 7×10⁷ erg/cm^{3 320}. The fabrication includes etching a bit patterned media (BPM) pattern 130. Etching a bit patterned media (BPM) pattern 130 includes a first BPM etch down to the thin inter-layer and thermal resistor layer 330 and alternatively a second BPM etch down to the top heat sink layer 340. Process continuation is described in FIG. 4 of one embodiment.

FIG. 4 shows a block diagram of an overview flow chart of partially etching the conformal plasmonic cladding layer of one embodiment. FIG. 4 shows processing continuing from FIG. 3 including depositing one or more conformal plasmonic cladding layer onto bit patterned media features 140 includes using a first atomic layer deposition (ALD1) 420. The conformal plasmonic cladding layer depositions includes using materials including 430 gold (Au) 432, silver (Ag) 434, copper (Cu) 436, aluminum (Al) 438 or the alloys of Au, Cu, Ag and Al 440. The conformal plasmonic cladding layer depositions includes using other materials with optical constant n<=1 and k>=2.5 450 of one embodiment.

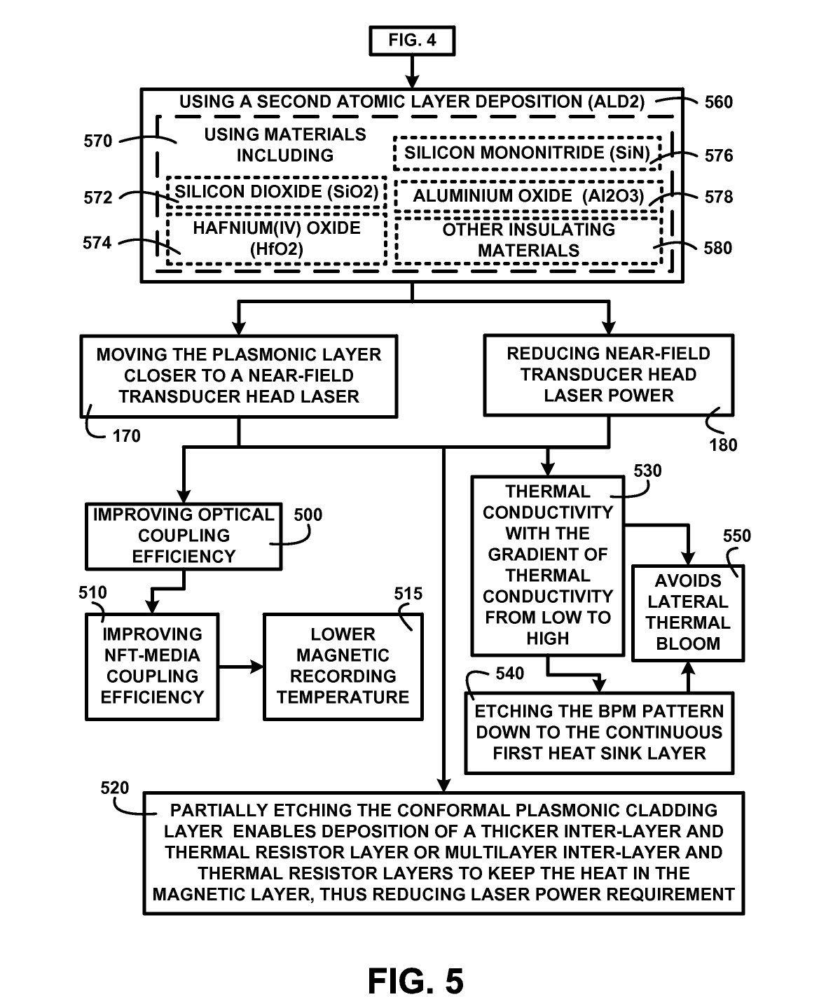

Fabrication continues including alternately partially etching the conformal plasmonic cladding layer (PCL) 160. Partially etching the conformal plasmonic cladding layer includes a first PCL etch in the BPM feature trenches 400, a second PCL etch on top of the BPM features 410 and a third PCL etch combining the first and second etch 415. The etching is patterning the one or more conformal plasmonic cladding layer (PCL) 417. Depositing a thermally insulating filler between BPM features 150 surrounds the conformal plasmonic cladding which is wrapped around the BPM features. Insulating the conformal plasmonic cladding wrapped around the BPM features retains heat in the magnetic layers. Processing includes depositing a thermally insulating filler between BPM features 150. Further descriptions are shown in FIG. 5 of one embodiment.

FIG. 5 shows a block diagram of an overview flow chart of improving NFT-media coupling efficiency of one embodiment. FIG. 5 shows a continuation from FIG. 4 and includes using a second atomic layer deposition (ALD2) 560 for the deposition of the thermally insulating filler including using materials including 570 silicon dioxide (SiO2) 572, hafnium(IV) oxide (HfO2) 574, silicon mononitride (SiN) 576, aluminum oxide (Al2O3) 578 and other insulating materials 580. Depositing one or more conformal plasmonic cladding layer onto bit patterned media features 140 of FIG. 1 is moving the plasmonic layer closer to a near field transducer head laser 170 and reducing near field transducer head laser power 180 of one embodiment.

Depositing one or more conformal plasmonic cladding layer onto bit patterned media features 140 of FIG. 1 is improving optical coupling efficiency 500 and improving NFT-media coupling efficiency 510. The method for fabricating plasmonic cladding moves the plasmonic layer closer to a near field transducer (NFT) to efficiently confine an optical source used to heat patterned features in the HAMR stack including bit patterned media features. Partially etching the conformal plasmonic cladding layer enables deposition of a thicker inter-layer and thermal resistor layer or multilayer inter-layer and thermal resistor layers to keep the heat in the magnetic layer, thus reducing laser power requirement 520. Thermal conductivity with the gradient of thermal conductivity from low to high 530 created by etching the BPM pattern down to the continuous first heat sink layer 540 avoids lateral thermal bloom 550 of one embodiment.

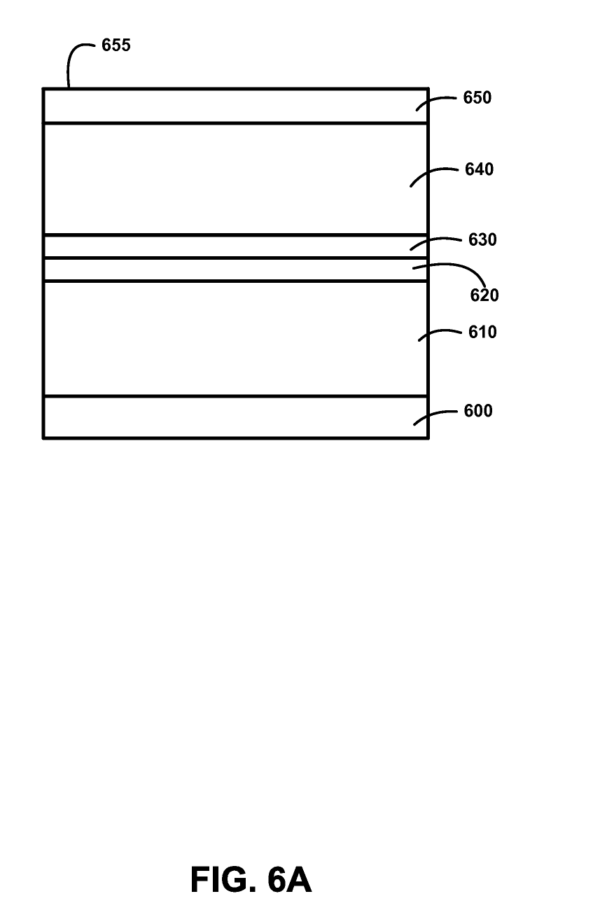

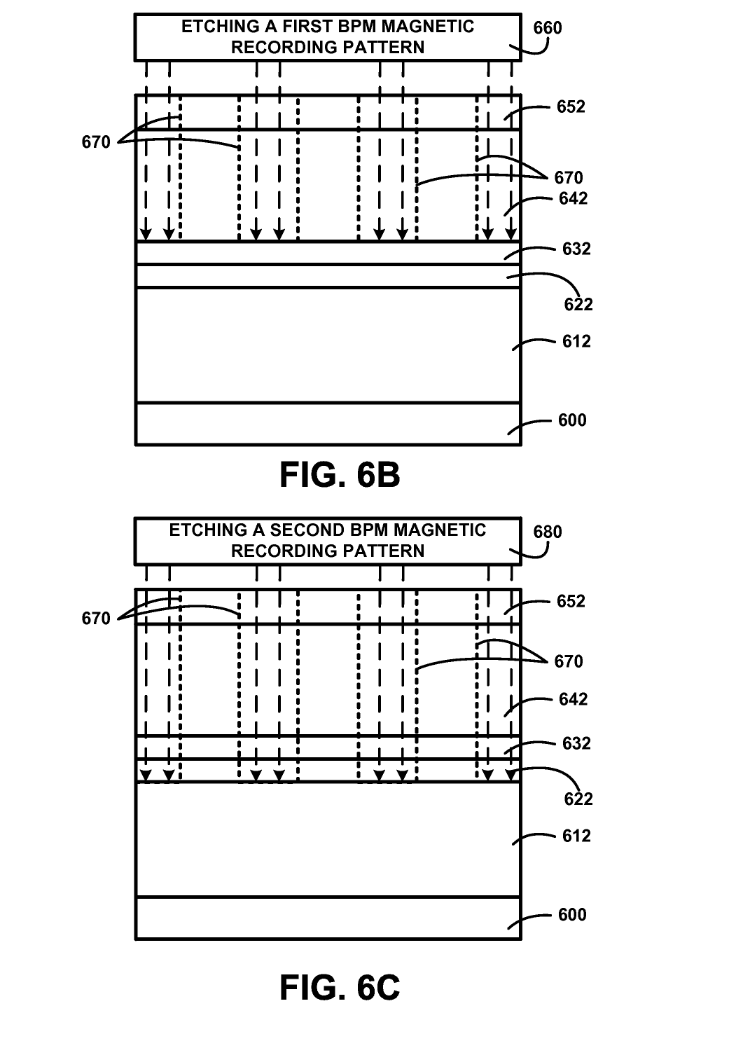

FIG. 6A shows for illustrative purposes only an example of a HAMR stack of one embodiment. FIG. 6A shows a heat assisted magnetic recording (HAMR) stack. The method for fabricating plasmonic cladding includes the HAMR stack 655 including a substrate 600. The HAMR stack 655 substrate 600 shows depositions thereon including a heat sink 1 (HS1) 610, a heat sink 2 (HS2) 620, thin interlayer and thermal resistor layer (IL & TR layer) 630, a magnetic layer 1 (MAG 1) 640 and a magnetic layer 2 (MAG 2) 650 of one embodiment.

FIG. 6B shows for illustrative purposes only an example of etching a first BPM magnetic recording pattern of one embodiment. FIG. 6B shows the HAMR stack 655 of FIG. 6A including the substrate 600, HS1 612, HS2 622, IL & TR layer 632, MAG 1 642 and MAG 2 652. Etching a first BPM magnetic recording pattern 660 includes a first BPM magnetic recording pattern 670 down to the thin inter-layer and thermal resistor layer 330 of FIG. 3 of one embodiment.

FIG. 6C shows for illustrative purposes only an example of etching a BPM second magnetic recording pattern of one embodiment. FIG. 6C shows the substrate 600, HS1 612, HS2 622, IL & TR layer 632, MAG 1 642 and MAG 2 652. FIG. 6C shows etching a second BPM magnetic recording pattern 680 including a second BPM magnetic recording pattern 675 down to the top heat sink layer 340 of FIG. 3 of one embodiment.

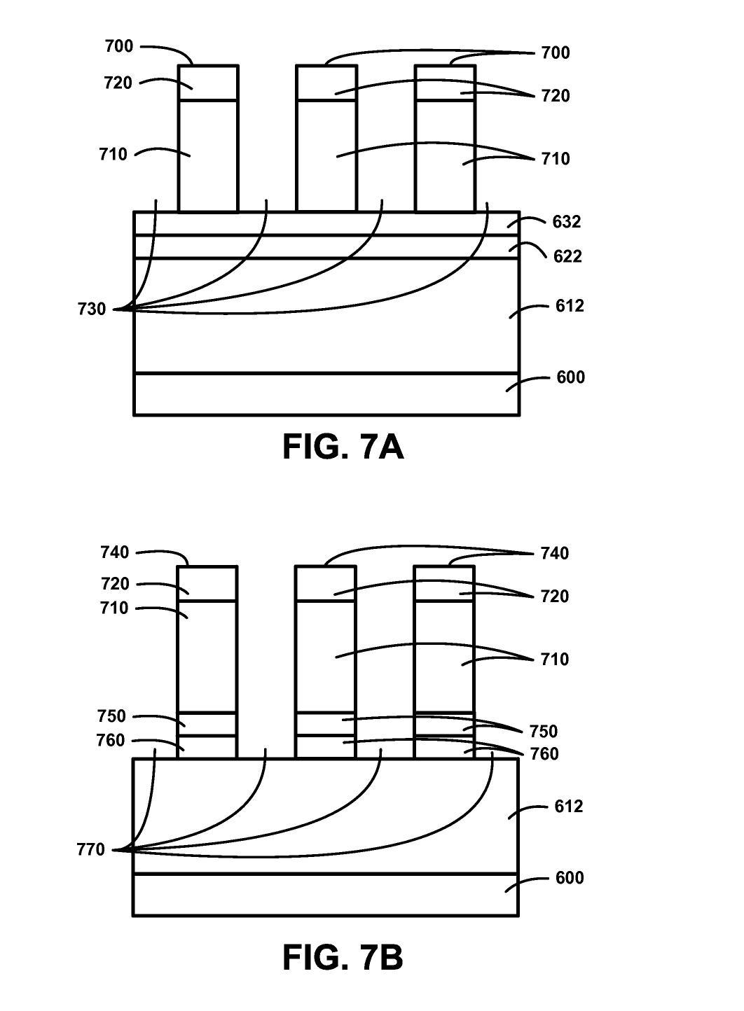

FIG. 7A shows for illustrative purposes only an example of a first BPM patterned feature of one embodiment. FIG. 7A shows the substrate 600 and non-patterned HS1 612, HS2 622 and IL & TR layer 632. A first BPM patterned feature (dot) 700 includes a patterned MAG 1 710 and patterned MAG 2 720. The top surface of the non-patterned IL & TR layer 632 between each first BPM patterned feature (dot) 700 is the trench 730 of one embodiment.

FIG. 7B shows for illustrative purposes only an example of a second BPM patterned feature of one embodiment. FIG. 7B shows the substrate 600 and non-patterned HS1 612. A second BPM patterned feature (dot) 740 includes a patterned HS2 760, patterned IL & TR layer 750 and the patterned MAG 1 710 and patterned MAG 2 720. The trench 770 of the second BPM patterned feature (dot) 740 is at the surface of the non-patterned HS1 612 of one embodiment.

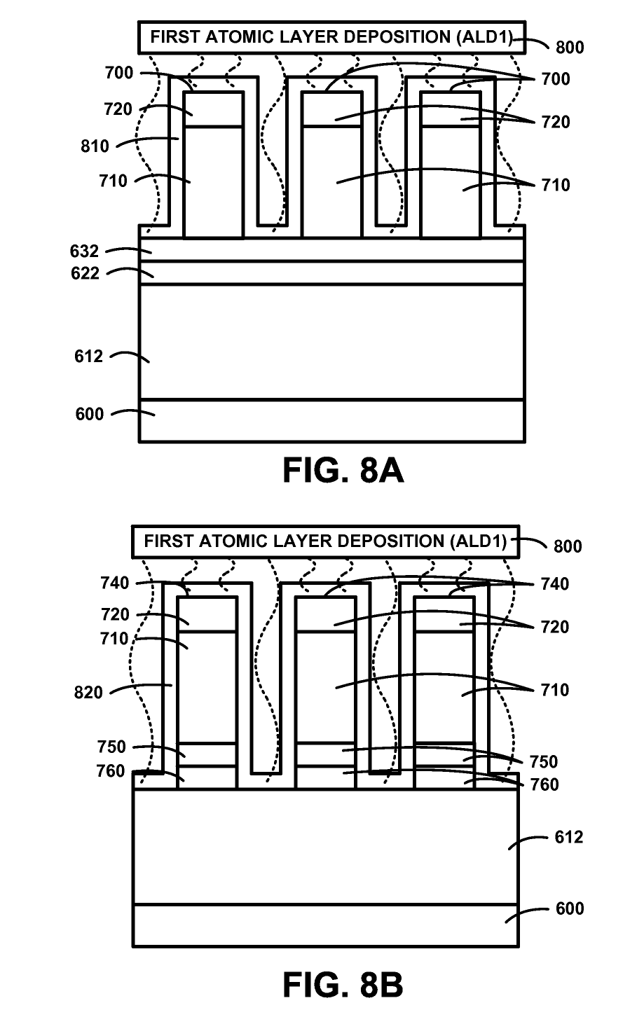

FIG. 8A shows for illustrative purposes only an example of first conformal plasmonic cladding of one embodiment. FIG. 8A shows the substrate 600 non-patterned HS1 612, HS2 622 and IL & TR layer 632. The first BPM patterned feature (dot) 700 is shown with the patterned MAG 1 710 and patterned MAG 2 720. An atomic layer deposition (ALD) 800 is used to deposit a first conformal plasmonic cladding 810 on the first BPM patterned feature (dot) 700 and trench 730 of FIG. 7A of one embodiment.

FIG. 8B shows for illustrative purposes only an example of second conformal plasmonic cladding of one embodiment. FIG. 8B shows the HAMR substrate 600 and the continuous HS1 612. The HAMR etched second BPM patterned feature (dot) 740 includes the patterned HS2 760, patterned IL & TR layer 750, patterned MAG 1 710 and patterned MAG 2 720. The atomic layer deposition (ALD) 800 deposits a second conformal plasmonic cladding 820 over the second BPM patterned feature (dot) 740 and in the trench 770 of FIG. 7B of one embodiment.

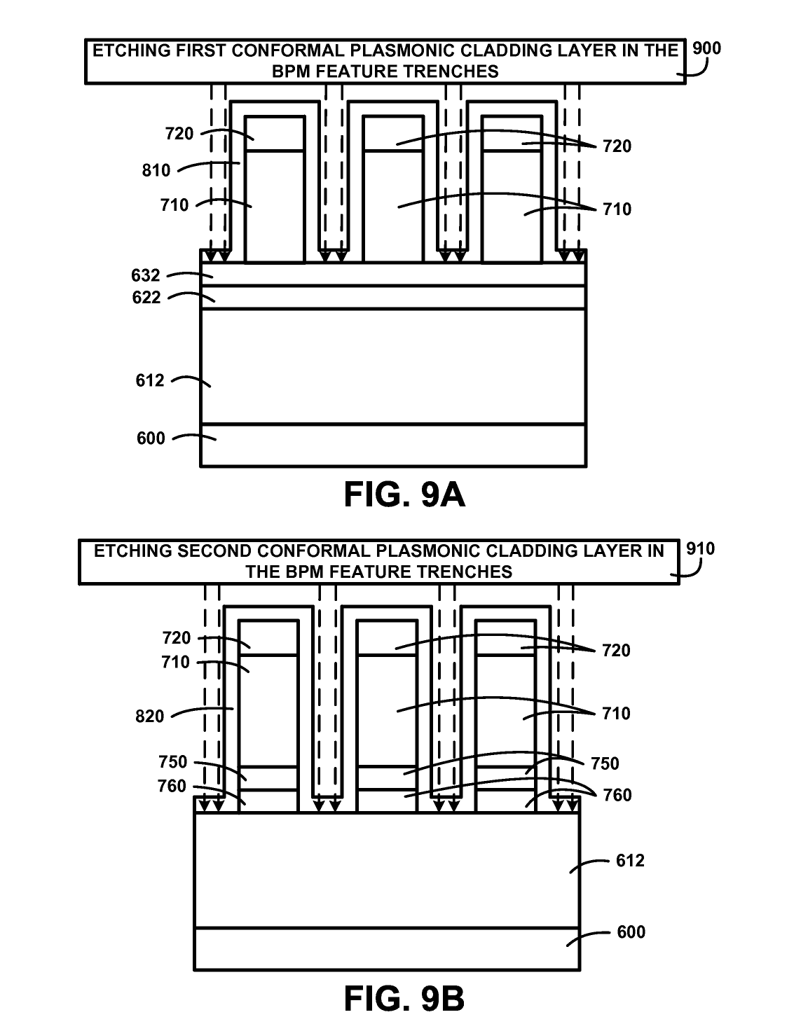

FIG. 9A shows for illustrative purposes only an example of etching first conformal plasmonic cladding layer in the BPM feature trenches of one embodiment. FIG. 9A shows the substrate 600, HS1 612, HS2 622, IL & TR layer 632 and the first BPM patterned feature (dot) 700 of FIG. 7A. The first BPM patterned feature (dot) 700 of FIG. 7A includes the patterned MAG 1 710 and patterned MAG 2 720. The first conformal plasmonic cladding 810 is partially patterned by etching first conformal plasmonic cladding layer in the BPM feature trenches 900. The etching is in the trench 730 of FIG. 7A to the surface of the IL & TR layer 632 of one embodiment.

FIG. 9B shows for illustrative purposes only an example of etching second conformal plasmonic cladding layer in the BPM feature trenches of one embodiment. FIG. 9B shows the substrate 600, HS1 612, patterned HS2 760, patterned IL & TR layer 750, patterned MAG 1 710 and patterned MAG 2 720 of the second BPM patterned feature (dot) 740. Partial patterning of the second conformal plasmonic cladding 820 is done by etching second conformal plasmonic cladding layer in the BPM feature trenches 910. The etching is made in the trench 770 of FIG. 7B of one embodiment.

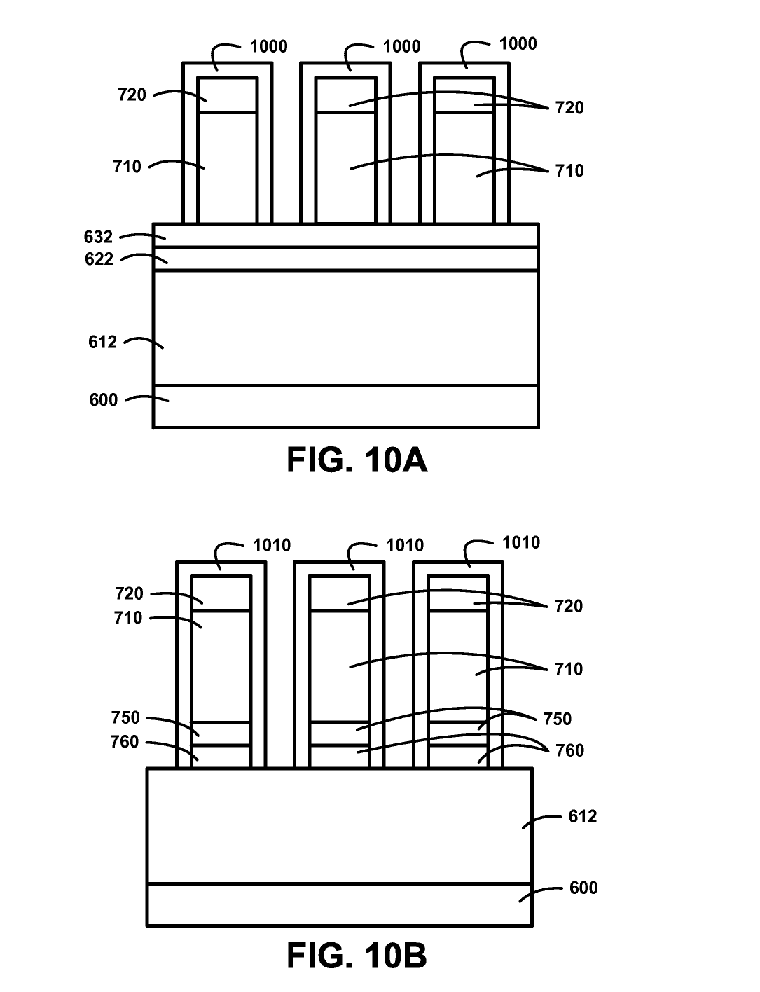

FIG. 10A shows for illustrative purposes only an example of partially etched first conformal plasmonic cladding down to the IL & TR layer of one embodiment. FIG. 10A shows the first BPM patterned feature (dot) 700 of FIG. 7A including the patterned MAG 1 710 and patterned MAG 2 720. The HAMR stack shown includes the first BPM patterned feature (dot) 700 of FIG. 7A, substrate 600, HS1 612, HS2 622, IL & TR layer 632 and partially etched first conformal plasmonic cladding down to the IL & TR layer 1000 of one embodiment.

FIG. 10B shows for illustrative purposes only an example of partially etched second conformal plasmonic cladding down to HS2 of one embodiment. FIG. 10B shows a HAMR stack including the substrate 600, HS1 612, patterned HS2 760, patterned IL & TR layer 750, patterned MAG 1 710 and patterned MAG 2 720. The second BPM patterned feature (dot) 740 includes the partially etched second conformal plasmonic cladding down to HS2 1010 of one embodiment.

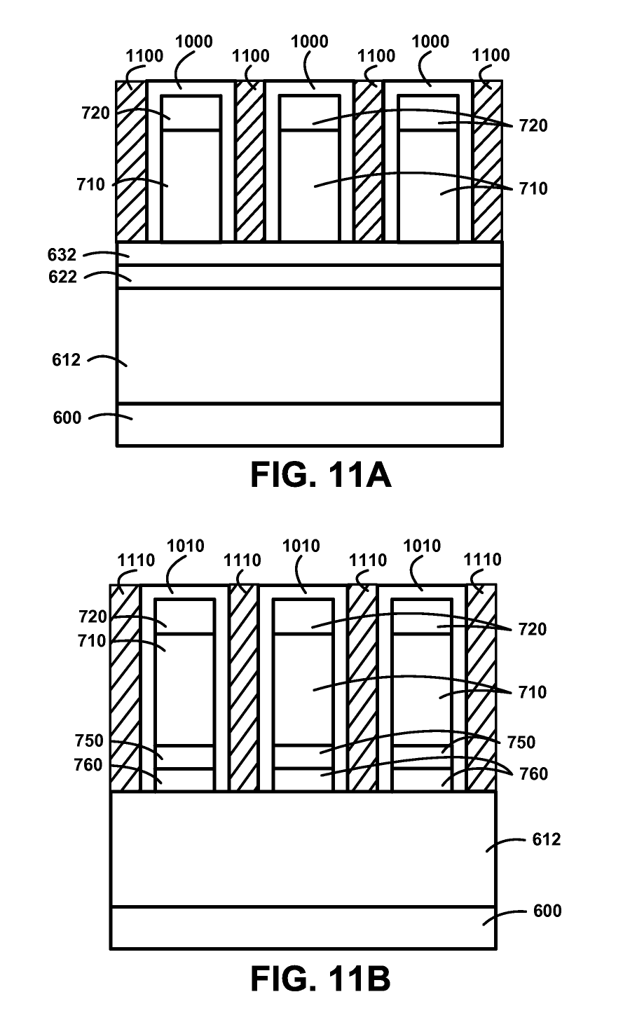

FIG. 11A shows for illustrative purposes only an example of a first thermally insulating filler deposition of one embodiment. FIG. 11A shows the substrate 600, HS1 612, HS2 622, IL & TR layer 632 and first BPM patterned feature (dot) 700 of FIG. 7A including the patterned MAG 1 710 and patterned MAG 2 720. The partially etched first conformal plasmonic cladding down to the IL & TR layer 1000 is shown with a first thermally insulating filler deposition 1100 between the cladded BPM patterned features of one embodiment.

FIG. 11B shows for illustrative purposes only an example of a second thermally insulating filler deposition of one embodiment. FIG. 11B shows the substrate 600, HS1 612, patterned HS2 760, patterned IL & TR layer 750, patterned MAG 1 710 and patterned MAG 2 720. The second BPM patterned feature (dot) 740 of FIG. 7B is shown with the partially etched second conformal plasmonic cladding down to HS2 1010 and the second thermally insulating filler deposition 1110 of one embodiment.

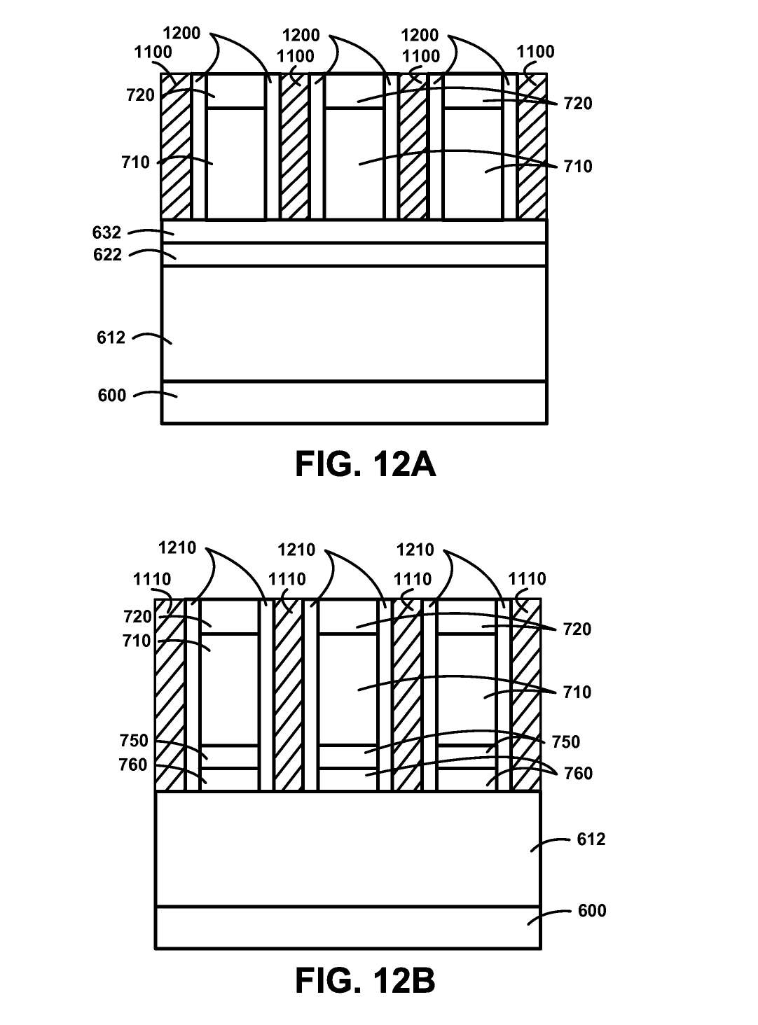

FIG. 12A shows for illustrative purposes only an example of first BPM patterned dot patterned plasmonic cladding of one embodiment. FIG. 12A shows the substrate 600, HS1 612, HS2 622, IL & TR layer 632 and first BPM patterned feature (dot) 700 of FIG. 7A including the patterned MAG 1 710 and patterned MAG 2 720. A partially etched third conformal plasmonic cladding 1200 is made using the third PCL etch combining the first and second etch 415 of FIG. 4 in the trenches and to the top of the BPM features. The first thermally insulating filler deposition 1100 is shown to the top of the BPM features of one embodiment.

FIG. 12B shows for illustrative purposes only an example of second BPM patterned dot patterned plasmonic cladding of one embodiment. FIG. 12B shows substrate 600, HS1 612, patterned HS2 760, patterned IL & TR layer 750, patterned MAG 1 710 and patterned MAG 2 720. The second BPM patterned feature (dot) 740 of FIG. 7B shows a partially etched fourth conformal plasmonic cladding down to heat sink 2 (HS2) 1210. The partially etched fourth conformal plasmonic cladding down to heat sink 2 (HS2) 1210 is made using the third PCL etch combining the first and second etch 415 of FIG. 4 in the trenches and to the top of the BPM features. The second thermally insulating filler deposition 1110 to the top of the BPM features of one embodiment.

Curie temperature (Tc), or Curie point, is the temperature where a material's permanent magnetism changes to induced magnetism, or vice versa. A rate of the heat flow is determined by the change in temperature (DT) over a period of time (Dt). The period of time can include the time in which external heat is being applied or where two materials in contact reach thermal equilibrium. The heat flow rate is expressed as a ratio DT/Dt where D stands for delta which means change. The force of magnetism is determined by magnetic moments of one embodiment.

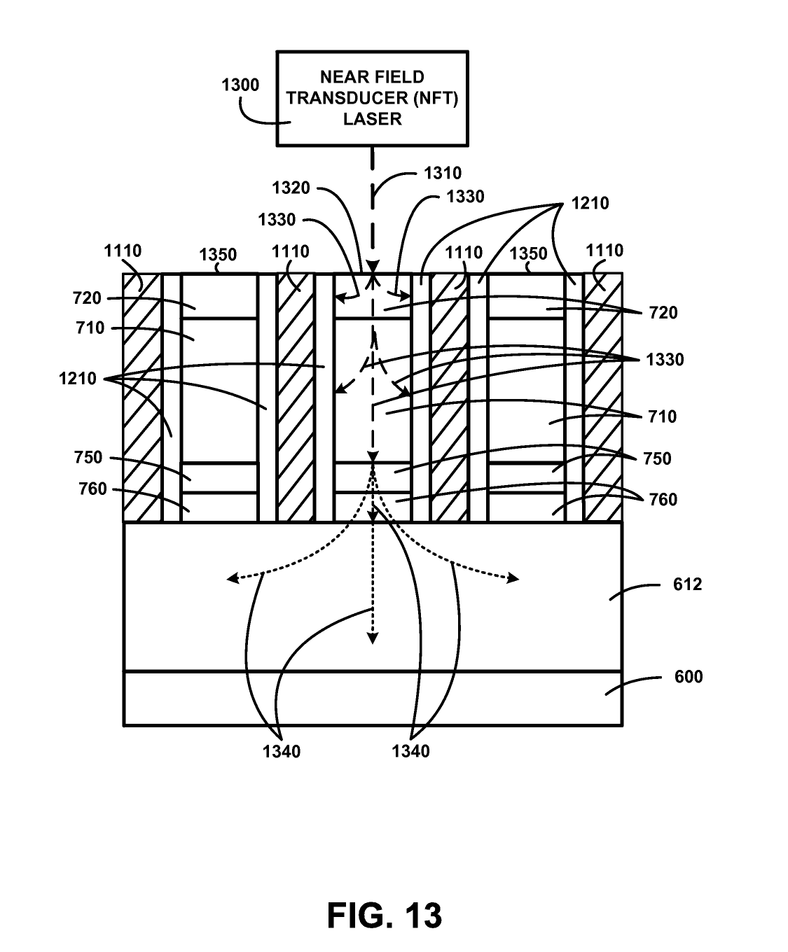

FIG. 13 shows for illustrative purposes only an example of avoiding lateral thermal bloom of one embodiment. FIG. 13 shows the substrate 600, HS1 612, patterned HS2 760, patterned IL & TR layer 750, patterned MAG 1 710 and patterned MAG 2 720 of the second BPM patterned feature (dot) 740. The second BPM patterned feature (dot) 740 includes the partially etched fourth conformal plasmonic cladding down to heat sink 2 (HS2) 1210 and the second thermally insulating filler deposition 1110 of one embodiment.

A near field transducer (NFT) laser 1300 can for example be a part of a read/write head. The near field transducer (NFT) laser 1300 is a laser power heating source to supply applied optical heat 1310 to the magnetic materials of the second BPM patterned feature (dot) 740 of one embodiment.

The partially etched fourth conformal plasmonic cladding down to heat sink 2 (HS2) 1210 confines the applied optical heat 1310 to the targeted second patterned BPM feature (dot) 1320 magnetic materials. The second thermally insulating filler deposition 1110 insulates the thermally conductive plasmonic cladding material and assists in retaining the applied optical heat 1310 to the targeted second patterned BPM feature (dot) 1320 magnetic materials. The applied optical heat 1310 is transferred throughout the magnetic materials by heat flow of conducted heat 1330. The conducted heat 1330 momentarily raises the temperature of patterned MAG 1 710 and patterned MAG 2 720 of the targeted second patterned BPM feature (dot) 1320. The near field transducer (NFT) laser 1300 continues heating the magnetic materials to a temperature to or above the Curie temperature (Tc) at which point the power to the laser is turned off. The partially etched fourth conformal plasmonic cladding down to heat sink 2 (HS2) 1210 is close to the near field transducer (NFT) laser 1300 and which amplifies coupling of one embodiment.

The partially etched fourth conformal plasmonic cladding down to heat sink 2 (HS2) 1210 confinement of heat, the insulation of the plasmonic cladding and magnetic materials raises the rate of the heat flow and the temperature of the magnetic materials quickly thereby reducing the time to reach the Tc threshold and thus reduces the power used by the near field transducer (NFT) laser 1300 of one embodiment.

A write module passes a current through the targeted second patterned BPM feature (dot) 1320 magnetic materials. The heat applied by the near field transducer (NFT) laser 1300 raises the temperature of the magnetic layers to or above the Tc of the magnetic materials. The magnetic materials switching fields vanishes at the Tc of the magnetic materials. The polarity of the targeted second patterned BPM feature (dot) 1320 can shift until the dissipation of the heat gain of the magnetic materials is sufficient to reduce the heated temperature of the targeted second patterned BPM feature (dot) 1320 below its Tc. When the heat introduced by the heating source is dissipated below the Tc or Curie point the magnetic state of the patterned feature is reestablished. The switching fields reappear with the reestablished magnetic state and take on the same polarity of the induced write module current of one embodiment.

The applied optical heat 1310 conducted through the magnetic materials is dissipated to the patterned IL & TR layer 750 materials. Heat dissipation 1340 continues into the patterned HS2 760 and then into the continuous HS1 612. The etching of the patterned IL & TR layer 750 and patterned HS2 760 removed the laterally extending materials avoiding the lateral conduction of heat to any adjacent second patterned BPM feature (dot) 1350. A thermal gradient structure of the patterned IL & TR layer 750 thermal resistive materials, low to medium thermal conductivity materials of the patterned HS2 760 and high thermal conductivity material of the continuous HS1 612 directs the heat dissipation 1340 down to HS1 612 through the targeted second patterned BPM feature (dot) 1320. The heat is not conducted laterally and thereby avoids lateral thermal bloom 550 of FIG. 5. The large mass of HS1 612 and its high thermal conductivity prevents conduction of heat to the low thermal conductivity of the patterned HS2 760 and thermal resistive materials of the patterned IL & TR layer 750 of any adjacent second patterned BPM feature (dot) 1350. The direction of the heat dissipation 1340 and avoidance of lateral thermal bloom stabilizes the thermal gradient of the HAMR stack 655 of one embodiment.

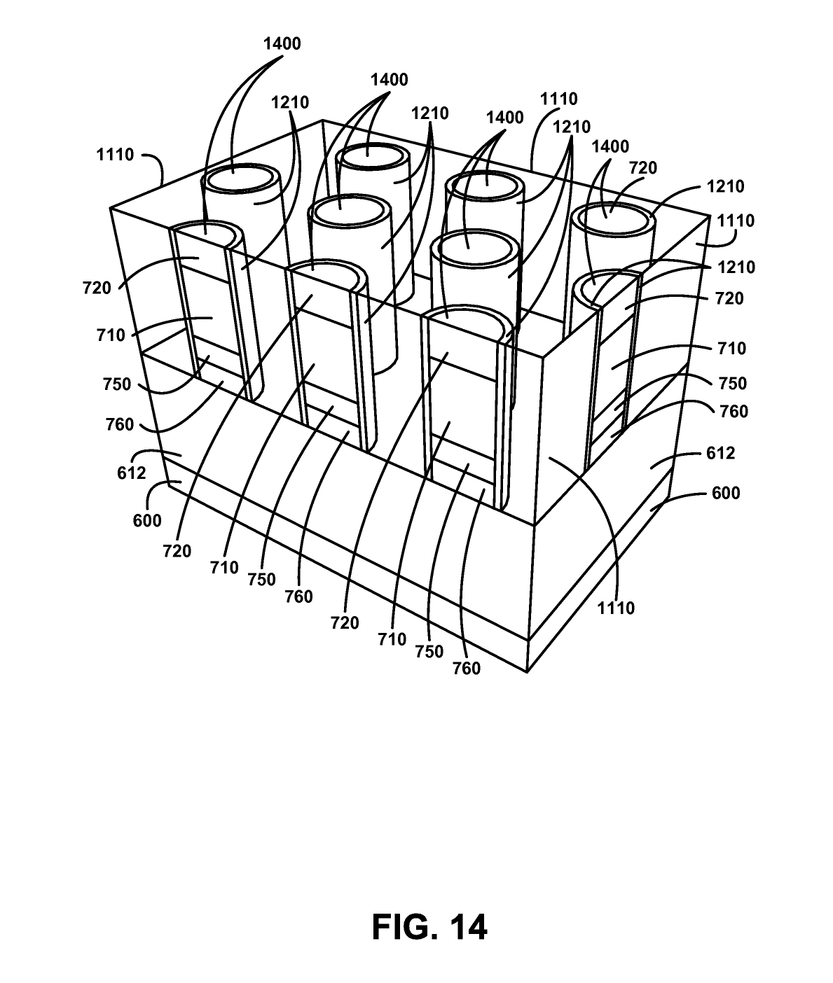

FIG. 14 shows for illustrative purposes only an example of a second BPM patterned feature with wrap around plasmonic cladding of one embodiment. FIG. 14 shows a prospective view of a HAMR stack 655 of FIG. 6A with a plurality of second BPM patterned feature (dot) 740 structures including the substrate 600, HS1 612, patterned HS2 760, patterned IL & TR layer 750, patterned MAG 1 710 and patterned MAG 2 720. The partially etched fourth conformal plasmonic cladding down to heat sink 2 (HS2) 1210 is shown with the second thermally insulating filler deposition 1110. The method for fabricating plasmonic cladding is used to create a BPM patterned HAMR media including a plurality of second BPM patterned feature (dot) with wrap around plasmonic cladding 1400 of one embodiment.

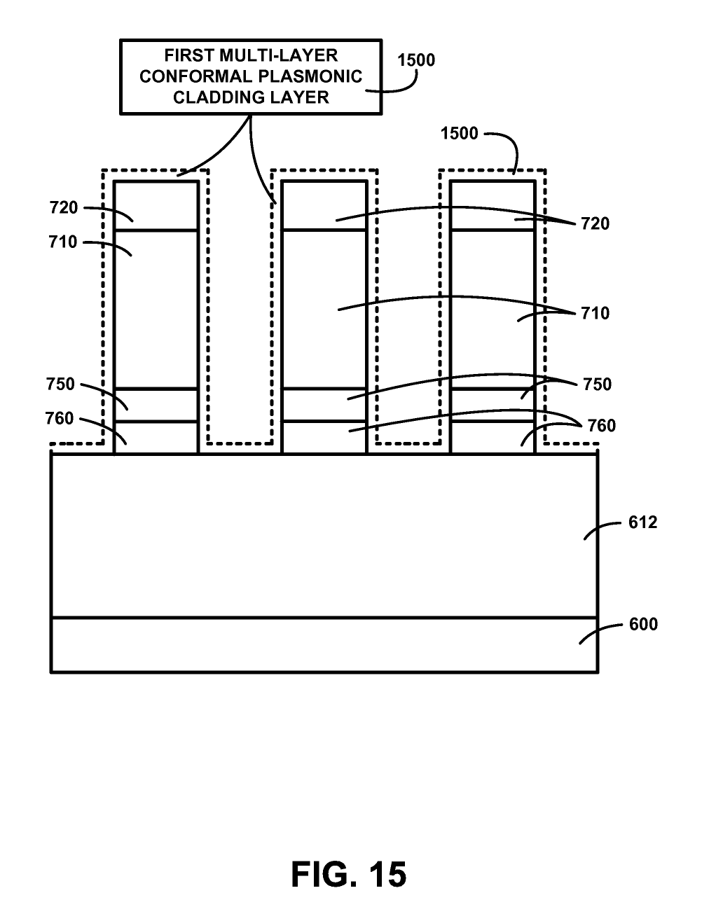

FIG. 15 shows for illustrative purposes only an example of a first multi-layer conformal plasmonic cladding layer of one embodiment. FIG. 15 shows the substrate 600, HS1 612, patterned HS2 760, patterned IL & TR layer 750, patterned MAG 1 710 and patterned MAG 2 720. The second BPM patterned feature (dot) 740 is shown with a first multi-layer conformal plasmonic cladding layer 1500 of a multi-layer plasmonic cladding of one embodiment.

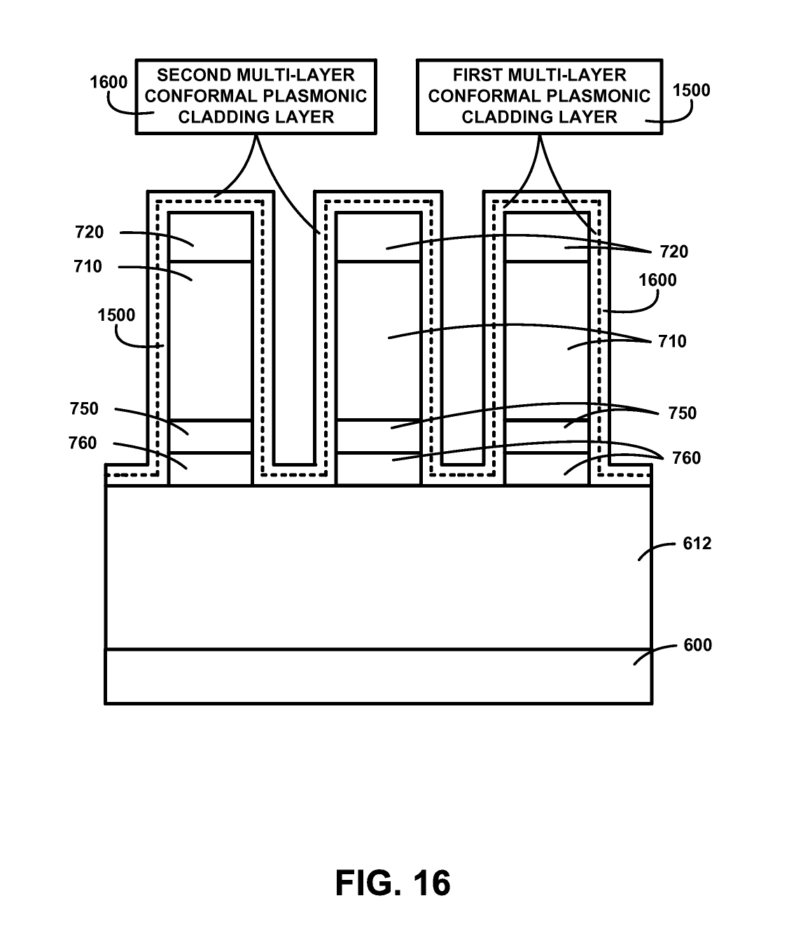

FIG. 16 shows for illustrative purposes only an example of a second multi-layer conformal plasmonic cladding layer of one embodiment. FIG. 16 shows the substrate 600, HS1 612, patterned HS2 760, patterned IL & TR layer 750, patterned MAG 1 710 and patterned MAG 2 720. The second BPM patterned feature (dot) 740 with the first multi-layer conformal plasmonic cladding layer 1500 includes a second multi-layer conformal plasmonic cladding layer 1600 deposited in the process to fabricate the multi-layer plasmonic cladding of one embodiment.

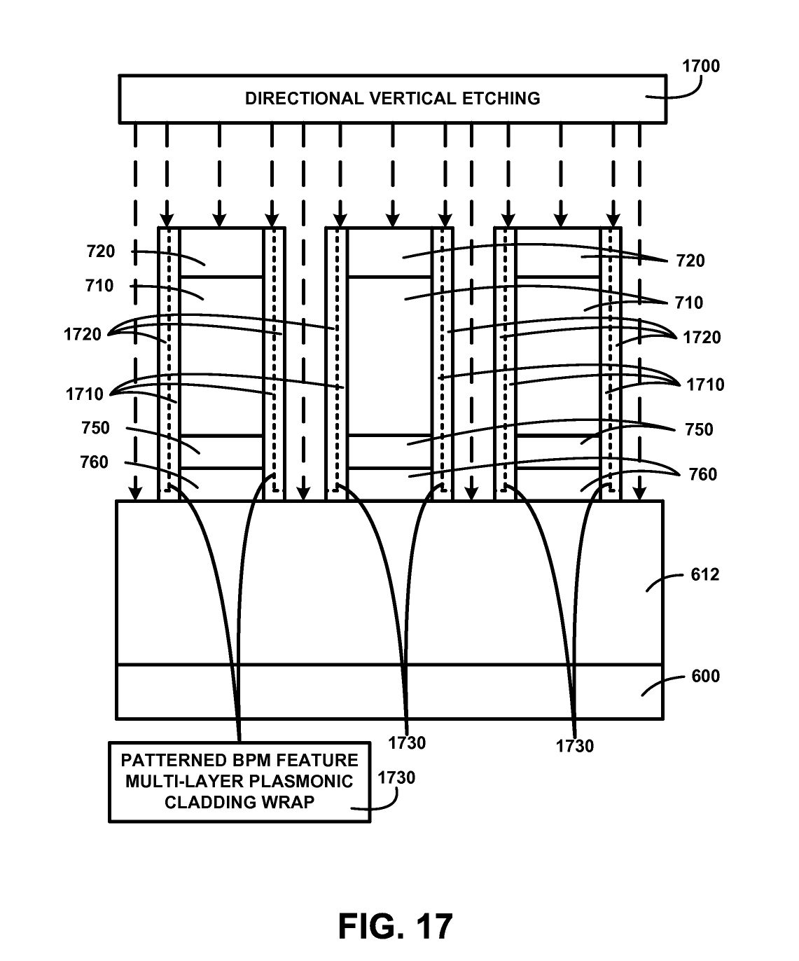

FIG. 17 shows for illustrative purposes only an example of directional vertical etching of one embodiment. FIG. 17 shows the substrate 600, HS1 612, patterned HS2 760, patterned IL & TR layer 750, patterned MAG 1 710 and patterned MAG 2 720. The second BPM patterned feature (dot) 740 includes a multi-layer plasmonic cladding patterning using a directional vertical etching 1700 including dry etching and reactive ion beam etching. The directional vertical etching 1700 creates a patterned first multi-layer conformal plasmonic cladding layer 1710 and patterned second multi-layer conformal plasmonic cladding layer 1720 making a patterned BPM feature multi-layer plasmonic cladding wrap 1730 on the plurality of second BPM patterned feature (dot) 740 of one embodiment.

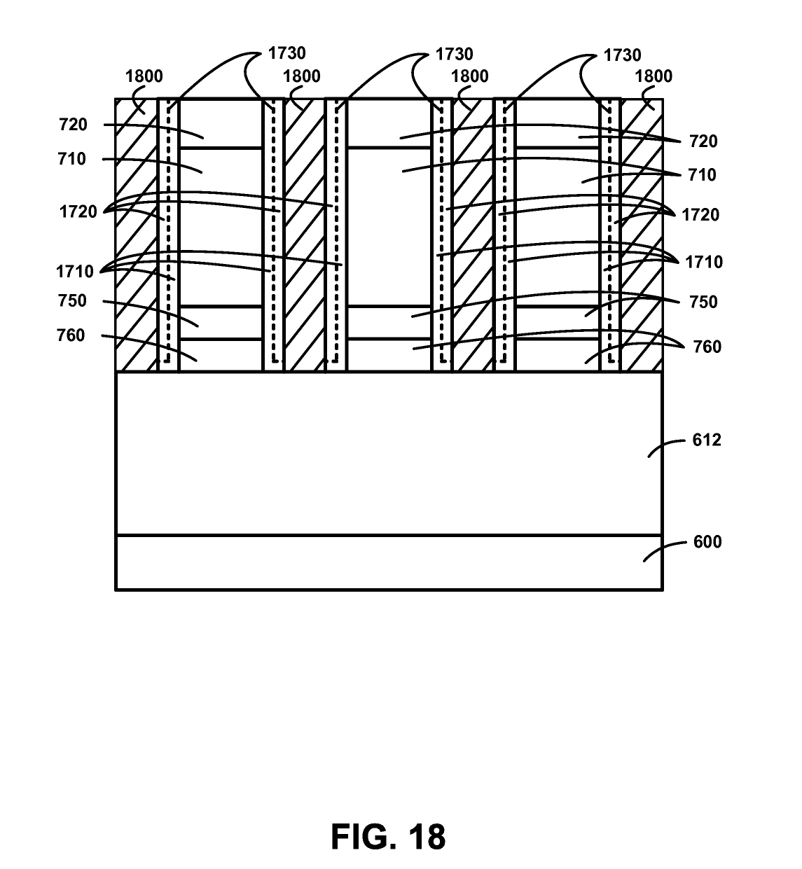

FIG. 18 shows for illustrative purposes only an example of patterned BPM feature multi-layer plasmonic cladding wrap of one embodiment. FIG. 18 shows the substrate 600, HS1 612, patterned HS2 760, patterned IL & TR layer 750, patterned MAG 1 710, patterned MAG 2 720 and partially etched fourth conformal plasmonic cladding down to heat sink 2 (HS2) 1210 wrapping around the second BPM patterned feature (dot) 740. The partially etched fourth conformal plasmonic cladding down to heat sink 2 (HS2) 1210 includes the patterned first multi-layer conformal plasmonic cladding layer 1710 and patterned second multi-layer conformal plasmonic cladding layer 1720. The patterned BPM feature multi-layer plasmonic cladding wrap 1730 is surrounded by a multi-layer plasmonic cladding wrap thermally insulating filler 1800 of one embodiment.

The foregoing has described the principles, embodiments and modes of operation. However, the invention should not be construed as being limited to the particular embodiments discussed. The above described embodiments should be regarded as illustrative rather than restrictive, and it should be appreciated that variations may be made in those embodiments by workers skilled in the art without departing from the scope as defined by the following claims.

What is claimed is:

1. A method comprising:
fabricating a stack with at least one conformal plasmonic cladding structure to wrap around a portion of patterned stack features; and
depositing a thermally insulating filler located between the stack features.

2. The method of claim 1, further comprising providing at least one thermally gradient heat sink layer including at least one continuous first heat sink layer (HS1) using materials with high thermal conductivity with k values from 10 to 400 k/(w m).

3. The method of claim 1, further comprising providing at least one thermally gradient heat sink layer including at least one gradient second heat sink layer using materials with low thermal conductivity with k values from 0.1 to 30 k/(w m), including copper alloys including Zirconium (Zr) and nickel (Ni) alloys, molybdenum (Mo) alloys, tungsten (W) alloys and Ruthenium (Ru) alloys to a thickness from 0.1 to 20 nm.

4. The method of claim 1, further comprising providing at least one thin inter-layer and thermal resistor layer including using materials including magnesium oxide (MgO), titanium nitride (TiN) alloys, and other thermal resistive materials to a thickness from 1 to 15 nm including magnesium oxide alloys (MgO—X) where alloys (X) include silicon (Si), niobium (Nb), tungsten (W), titanium (Ti), tantalum (Ta) and other alloys and including Titanium nitride alloys (TiN—Y) where alloys (Y) include aluminum (Al), ruthenium (Ru), silicon (Si), oxygen (O), silver (Ag), gold (Au) and other alloys.

5. The method of claim 1, further comprising providing at least one anisotropic gradient magnetic layer including using ferromagnetic materials including iron-platinum (FePt) and FePtX alloys where X is an alloy including materials with high anisotropy magnetic where a crystalline anisotropy constants are at or above 7×10⁷ erg/cm3.

6. The method of claim 1, further comprising etching bit patterned media features into a first magnetic layer and a second magnetic layer down to a recording pattern features down to continuous first heat sink layer.

7. The method of claim 1, further comprising providing an atomic layer made with materials including gold (Au), silver (Ag), copper (Cu), aluminum (Al) or the alloys of Au, Cu, Ag and Al and other materials with optical constant n<=1 and k>=2.5.

8. The method of claim 1, further comprising partially etching at least one conformal plasmonic cladding layer including a first plasmonic cladding layer (PCL) etch in the bit patterned media feature trenches, a second PCL etch on top of the bit patterned media features and a third PCL etch combining the first and second etch using directional vertical etching including dry etching and reactive ion beam etching, wherein alternatively the conformal plasmonic cladding structure is etched from top surfaces of the stack features exposing magnetic layer materials.

9. The method of claim 1, further comprising depositing a thermally insulating filler including using materials including silicon dioxide (SiO2), hafnium(IV) oxide (HfO2), silicon mononitride (SiN), aluminum oxide (Al2O3) or an atomic layer deposition (ALD).

10. The method of claim 1, further comprising using the conformal plasmonic cladding structure to amplify optical coupling and to reduce an amount of energy from a laser source being applied to heat the stack features, further comprising exposing magnetic layer materials directly to the laser is used to speed-up the heating process, and further comprising using the thermally insulating filler to reduce radiant heat transfers to adjacent stack features, thereby allowing closer proximity of stack features to increase densities.

11. A plasmonic cladding apparatus, comprising:
a deposition of at least one conformal plasmonic cladding layer to wrap around portion stack features of a recording device;
a pattern etched on at least one conformal plasmonic cladding layer by partially etching top surfaces of the stack features; and
a thermally insulating filler used for insulating the stack features.

12. The apparatus of claim 11, further comprising a deposition of at least one plasmonic cladding layer configured to include using materials with optical constant n<=1 and k>=2.5 including using materials including gold (Au), silver (Ag), copper (Cu), aluminum (Al) or the alloys of Au, Cu, Ag and Al and other materials including magnesium oxide alloys (MgO—X) where alloys (X) include silicon (Si), niobium (Nb), tungsten (W), titanium (Ti), tantalum (Ta) and other alloys and including Titanium nitride alloys (TiN—Y) where alloys (Y) include aluminum (Al), ruthenium (Ru), silicon (Si), oxygen (O), silver (Ag), gold (Au) and other alloys.

13. The apparatus of claim 11, further comprising a deposition of at least one conformal plasmonic cladding layer configured to include using an atomic layer deposition.

14. The apparatus of claim 11, further comprising a pattern partially etched into at least one conformal plasmonic cladding layer configured to include a first plasmonic cladding layer (PCL) etch in the bit patterned media feature trenches, a second PCL etch on top of the bit patterned media features and a third PCL etch combining the first and second etch using directional vertical etching including dry etching and reactive ion beam etching.

15. The apparatus of claim 11, further comprising means a deposition of a thermally insulating filler surrounding patterned plasmonic cladding between bit patterned media features and configured to include using insulating materials including silicon dioxide (SiO2), hafnium (IV) oxide (HfO2), silicon mononitride (SiN), aluminum oxide (Al2O3) and other insulating materials using an atomic layer deposition.

16. A plasmonic cladding structure, comprising:
at least one conformal plasmonic cladding structure wrapped around a portion of plural stack features of a recording device, wherein the conformal plasmonic cladding structure is configured to reduce power of a near-field transducer;
at least one conformal plasmonic cladding structure with substantially removed top surfaces of the stack features with exposed magnetic layer materials; and
a thermally insulating filler configured to be located between the stack features.

17. The structure of claim 16, further comprising at least one thermally gradient heat sink layer configured to include at least one a continuous first heat sink layer configured to include using materials with high thermal conductivity with k values from 10 to 200 k/(w m) and depositing at least one gradient second heat sink layer onto the first heat sink layer using materials with low thermal conductivity with k values from 0.1 to 30 k/(w m), including copper alloys including Zirconium (Zr) and nickel (Ni) alloys, molybdenum (Mo) alloys, tungsten (W) alloys and Ruthenium (Ru) alloys and configured to include a thickness from 0.1 to 20 nm.

18. The structure of claim 16, further comprising at least one anisotropic gradient magnetic layers configured to include using ferromagnetic materials including iron-platinum (FePt) and FePtX alloys where X is an alloy including materials with high anisotropy magnetic where a crystalline anisotropy constants are at or above 7×10⁷ erg/cm3.

19. The structure of claim 16, further comprising at least one conformal plasmonic cladding layer configured to include using an atomic layer deposition and is configured to includes using materials including gold (Au), silver (Ag), copper (Cu), aluminum (Al) or the alloys of Au, Cu, Ag and Al and other materials with optical constant n<=1 and k>=2.5, and configured to include exposing magnetic layer materials directly to the laser configured to include speed-up the heating process, and wherein the conformal plasmonic cladding structure is configured to be used to amplify optical coupling and configured to reduce an amount of energy from a laser source being applied to heat the stack features to a power level <50 nW at the top surface of a stack feature.

20. The structure of claim 16, wherein the thermally insulating filler configured to include using materials including silicon dioxide (SiO2), hafnium(IV) oxide (HfO2), silicon mononitride (SiN), aluminum oxide (Al2O3) and other insulating materials using an atomic layer deposition (ALD) and configured to reduce radiant heat transfers to adjacent stack features, thereby allowing closer proximity of stack features to increase densities.
